(19) United States
(12) Patent Application Publication
(10) Pub. No.: US 2024/0202008 A1
(43) Pub. Date: Jun. 20, 2024

(54) SHUTDOWN OF PREEMPTIBLE NODES ON MANAGED CLUSTERS

(71) Applicant: Oracle International Corporation, Redwood Shores, CA (US)

(72) Inventors: Ravi Prakash Palacherla, Denver, CO (US); Aseem Bajaj, Pleasanton, CA (US); Kayla Nicole Carrera, Palm Springs, CA (US); Joshua Aaron Horwitz, Centreville, VA (US)

(73) Assignee: Oracle International Corporation, Redwood Shores, CA (US)

(21) Appl. No.: 18/537,278

(22) Filed: Dec. 12, 2023

Related U.S. Application Data
(60) Provisional application No. 63/433,396, filed on Dec. 16, 2022.

(51) Int. Cl. G06F 9/4401

(52) U.S. Cl. CPC G06F 9/442

(57) ABSTRACT

Conventional techniques for shutting down preempted nodes includes drawbacks to cloud users and service providers alike. The disclosed techniques are directed to mitigating or eliminating these drawbacks. Upon receiving a preemptible node request, a preemptible node may be generated, labeled as having a particular capacity type, and added to a cluster managed by a cluster manager. In response to detecting the label, the cluster manager may deploy a containerized application to the preemptible node. The containerized application may monitor node metadata to detect preemption of the node. Node metadata may be provided by node metadata service executing at a smart network interface card connected to a host on which the preemptible node executes. In response to detecting preemption, the containerized application may initiate shutdown and/or replacement operations of the preemptible node to reduce or eliminate the negative impact of preemption.

### CROSS-REFERENCE TO RELATED APPLICATIONS

This non-provisional application claims priority to U.S. Provisional Patent Application No. 63/433,396, filed on Dec. 16, 823, entitled “Shutdown of Preemptible Nodes on Managed Clusters,” the disclosure of which is herein incorporated by reference in its entirety for all purposes.

### BACKGROUND

Cloud service providers may offer preemptable nodes that can be evicted from a host when the host is needed (e.g., to provide capacity elsewhere). Currently, customers have no notice that the node is going to be evicted. In this context, executing procedures to wind down the workflows executing at the preempted node would require delaying shutdown of the node. Cloud service providers generally do not allow preemptable nodes to delay shutdown because the delay may violate various service level agreements. Thus, current node preemption techniques include drawbacks to customers and the cloud service provider alike. Improvements for handling node preemption are desirable.

### BRIEF SUMMARY

Embodiments of the present disclosure relate to techniques for handling node preemption.

At least one embodiment is directed to a computer-implemented method. The method may include executing a cluster management service configured to manage a cluster comprising a plurality of nodes that are individually configured to execute one or more containerized applications. The method may include receiving, by the cluster management service, a request for a preemptible node. The method may include executing operations that cause the preemptible node to be generated and associated with a label that indicates a preemptible capacity type. The method may include responsive to detecting that the preemptible node is associated with the label, deploying, by the cluster management service, a containerized application to the preemptible node. In some embodiments, the containerized application may be configured to detect preemption of the preemptible node and trigger the cluster management service to execute a set of shutdown operations corresponding to the preemptible node.

The method may further include implementing, by the cluster management service, a deployment controller that is configured to deploy the containerized application to preemptible nodes that are individually associated with the label indicating the preemptible capacity type.

In some embodiments, executing the operations that cause the preemptible node to be generated and associated with the label comprises transmitting, to a compute service, instructions to generate the preemptible node according to a preemptible node configuration. In some embodiments, generating the preemptible node causes the compute service to associate the preemptible node with preemptible metadata (e.g., a label) defined by the preemptible node configuration.

In some embodiments, generating the preemptible node causes a script to be executed that 1) identifies the preemptible node as being of the preemptible capacity type based at least in part on the preemptible metadata associated with the preemptible node and 2) associates the preemptible node with the label that indicates the preemptible capacity type.

In some embodiments, triggering the cluster management service to execute the set of shut down operations comprises transmitting, by the containerized application to the cluster management service, a preemption message that indicates that a preemption event corresponding to the preemptible node has occurred.

The method may further include, responsive to receiving a preemption message from the containerized application, removing one or more containers executing on the preemptible node from a list of candidate containers to which new workloads are assignable.

In some embodiments, the containerized application is configured to detect the preemption of the preemptible node based at least in part on obtaining data from a node metadata service component executing at a device associated with the preemptible node.

In some embodiments, the device executing the node metadata service component executes at a smart network interface card that is communicatively connected to a host device on which the preemptible node executes.

In some embodiments, responsive to receiving a preemption message from the containerized application, a shutdown signal may be transmitted (e.g., by the cluster management service) to one or more workloads being executed by the preemptible node.

In some embodiments, a preemptible capacity type identifies the preemptible node as being reclaimable capacity that lacks a time guarantee.

In some embodiments, the containerized application monitors node metadata provided by a node metadata service. In some embodiments, the node metadata indicates that the preemption of the preemptible node has been initiated.

In some embodiments, the cluster management service assigns low priority workloads to the preemptible node.

In some embodiments, the containerized application is configured to detect the preemption of the preemptible node based at least in part on monitoring messages issued by a node metadata service.

In some embodiments, the preemption of the preemptible node is triggered based at least in part on a second request for an on-demand node that is unavailable due to current on-demand capacity of the cloud computing system.

In some embodiments, the request for the preemptible node requests addition of a pool of preemptible nodes.

In some embodiments, executing the operations that cause the preemptible node to be associated with the label further comprises associated each preemptible node of the pool of preemptible nodes with the label.

In some embodiments, the set of shutdown operations comprise cordon and drain operations provided by a Kubernetes engine.

In some embodiments, one or more requests may be transmitted for a replacement preemptible node corresponding to the preemptible node.

Another embodiment is directed to a cloud-computing service comprising one or more processors and memory storing instructions that, when executed by the one or more processors, cause the cloud-computing service to perform the method(s) disclosed herein.

Still another embodiment is directed to a non-transitory computer-readable medium storing computer-executable instructions that, when executed by one or more processors of a cloud-computing service, cause the cloud-computing service to perform the method(s) disclosed herein.

### BRIEF DESCRIPTION OF THE DRAWINGS

To easily identify the discussion of any particular element or act, the most significant digit or digits in a reference number refer to the figure number in which that element is first introduced.

FIG. 1 shows a simplified diagram of an exemplary cloud-computing environment including a managed cluster, according to at least one embodiment.

FIG. 2 shows a simplified diagram of an exemplary cloud-computing environment including multiple fault domains within an availability domain, according to at least one embodiment.

FIG. 3 shows a simplified diagram depicting example cloud-computing components with which one or more preemptible nodes may be generated and configured, according to at least one embodiment.

FIG. 4 includes a flow diagram depicting an example method for generating and labeling a preemptible node, according to at least one embodiment.

FIG. 5 depicts an example user interface for requesting one or more preemptible nodes, according to at least one embodiment.

FIG. 6 illustrates an example method for detecting and responding to a preemption event corresponding to a preemptive node, according to at least one embodiment.

FIG. 7 is a block diagram depicting an example method managing preemptable nodes, in accordance with at least one embodiment.

FIG. 8 is a block diagram illustrating one pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

A cloud service provider can allow a customer to schedule and run containerized workloads on distributed computing resources. These containerized workloads may include program code that is packaged with corresponding configuration files, dependencies, and libraries needed to execute the code. One or more containers may be deployed to a host device (e.g., a compute node, or “node,” for brevity). Each container may include its own filesystem, share of CPU memory, process space, etc. Containers are similar to virtual machines, in that they run on hardware of the same node, but they have relaxed isolation properties that enable them to share the operating system of the host device. A container runtime executing at the host device may be configured to manage the containers. In some cases, any suitable number of containers may be packaged together in a “pod” (e.g., by a cluster manager, prior to deployment) to maximize the benefits of resource sharing. Grouping containers this way allows the containers of a pod to communicate between each other as if they shared the same physical hardware, while maintaining some degree of isolated. As the containers are decoupled from the underlying infrastructure, they are portable across clouds and OS distributions. Therefore, the use of containerized workloads (e.g., workloads executed using the resources associated with a container) is beneficial because the code can execute reliably regardless of the specific node on which it executes. A container may include program code for an application that, when executed, performs operations corresponding to a containerized workload. The nodes hosting and executing the containerized applications/workloads can be organized into clusters comprising one or more nodes.

A “cluster” in this cluster architecture can be viewed as a single entity from a customer's perspective. A cloud service provider application programming interface (API) can be utilized to receive containerized applications and/or workloads which may then be allocated to the nodes in the cluster without the customer specifying which node will execute the corresponding containers. This alleviates the customer from having to manage the scheduling and deployment of these containers to the particular nodes on which they will execute. This cluster architecture is flexible, and a customer can scale the cluster, by adding or removing nodes, to adjust for changes in demand or to accommodate different workloads.

Customers can use the cloud service provider's application programming interface to request that the cloud service provider add a node to their cluster. The request can include parameters for the new node including a shape for the node, a region for the node, and a base image for the node, and, in addition, the request can specify the availability for the node. Once the node has been added to their cluster, the customer can request access to their node through the cloud service provider's application programming interface (API). The customer's access to the node is determined by the node's availability, and the cloud service provider can provide nodes with on-demand availability and preemptable availability, among other capacity types.

Nodes with on-demand availability, (e.g., on-demand nodes), are available at the customer's request for a period of time agreed upon between the customer and the cloud service provider. A node configured with preemptable availability can be accessed by the customer indefinitely, as long as the cloud service provider has spare capacity with which on-demand resources may be fulfilled. Preemptable nodes, unlike on-demand nodes, are revokable at any time, and a preemptable node may be preempted (e.g., reclaimed) by the system, if the underlying resource is needed to host an on-demand node.

On-demand nodes have higher availability, and a customer can log on to their node at will, but such nodes can be more expensive. Preemptible nodes may be less expensive due to the potential workload interruption if the node is preempted by the cloud service provider due to capacity requirements. Consequently, preemptable nodes provide advantages over on-demand resource utilizing, especially for workloads that are not time sensitive (e.g., payroll processing that needs to be done in a week rather than a point-of-sale fielding purchase requests that need to be completed rapidly) and/or that are fault and/or interruption tolerant.

Preemption of a node is intended to refer to situation in which the node is being reclaimed by the system (for any suitable purpose, for example, to provide a different type of capacity such as on-demand capacity). Preempting a node may include shutting down and/or removing containers and/or deprovisioning or releasing the reservation of the host hardware (e.g., so as to enable the reservation and use of that hardware for a different purpose). This deprovisioning may be enforced by the software managing the node, such as firmware, an operating system, or hypervisor. In some embodiments, a node management service of the cloud-computing environment may have advance notice of the preemption (e.g., an indication that eviction/termination of the pods and/or containers running on the computing hardware of the node is planned).

The node management service may collect metadata associated with the node over time from a variety of cloud-computing sources. By way of example, a compute service that is responsible for generating/configuring nodes for use may transmit data that is received and maintained by the node management service. A component of the node management service may execute at the host device and/or at a device communicatively connected to the host device. For example, the node management service (an example of an application, an agent, an instance of the node management service, etc.) may execute at a smart network interface card (NIC) that is communicatively connected to the host device. The node management service may receive an indication that a preemptable node is about to be evicted (e.g., an eviction indicator). This indication may be considered a “preemption event.” In some embodiments, the eviction indicator may indicate a time by which the node will be evicted (e.g., until pods and/or containers of the node will be terminated to free up the node for other use). For example, the eviction indicator may include a timer or time period that indicates when eviction operation execution is planned (e.g., two minutes until eviction).

A containerized application (also referred to as a “termination handler”) executing on a preemptable node may be configured to monitor the metadata provided by the node management service to determine if the node is scheduled for eviction. Monitoring the node management service may include polling the node management service (e.g., periodically, according to a predefined frequency, according to a predefined event or schedule, etc.) for an eviction indicator (e.g., node metadata that includes an indication of planned eviction). In some implementations, the node management service may transmit an eviction indicator (and/or node metadata) to the containerized application at any suitable time (e.g., periodically, according to a predefined frequency, if the service detects a pending eviction, according to a predefined event or schedule, etc.).

Upon detecting an eviction, the containerized application may attempt to gracefully shutdown the preemptable node. Sudden or abrupt shutdown can cause previously executing workloads to fail or become corrupted. To reduce risk of failure or corruption, a variety of shutdown operations can be executed when an eviction indicator is detected. These operations may include, but are not limited to, executing operations to avoid assignment of new workloads to the preemptive node, sending shutdown signals to a currently executing workload, or both.

By ensuring new workloads are not assigned to the preempted node the risk of workload execution failure may be reduced. Additionally, sending shutdown signals (e.g., making calls to custom code or hooks in the workload) can allow executing workloads to save progress and exit successfully without failing or becoming corrupted. These techniques enable the node to shutdown successfully without delaying the preemption and potentially violating service level agreements for the on-demand nodes that will subsequently execute at the host device.

In an illustrative example, a customer may request that a preemptible node is added to hist cluster to run a workload. The customer may device to select a preemptive node rather than an on-demand node because the preemptive node is half the price of the on-demand node. The cloud services provider may provision the node. In some embodiments, the node may be labeled as being associated with a preemptible capacity type or otherwise tagged or flagged as being a preemptable node. After provisioning the host device, a cluster management service adds a containerized application to the node. This containerized application may monitor the node's metadata for a preemption event. In the meantime, the workloads execute on the node inside their own containers.

After successfully running for several hours, the containerized application detects a preemption event and determines that the node will be evicted from the host device in two minutes. In response, the containerized application sends messages to the cluster manager requesting that the cluster manager stops assigning new workloads to the preemptive node and that the service send stop signals to the nodes' current workloads. The shutdown signals cause the workloads to wind down and, because no new workloads are assigned to the node, the number of workloads executing on the preemptive node decreases. Accordingly, the preemptive node successfully shuts down after two minutes without corrupting any of the node's workloads. At least some of the shutdown procedures executed in response to detecting a preemption event may include cardon and drain operations (e.g., Kubernetes cardon and drain operations).

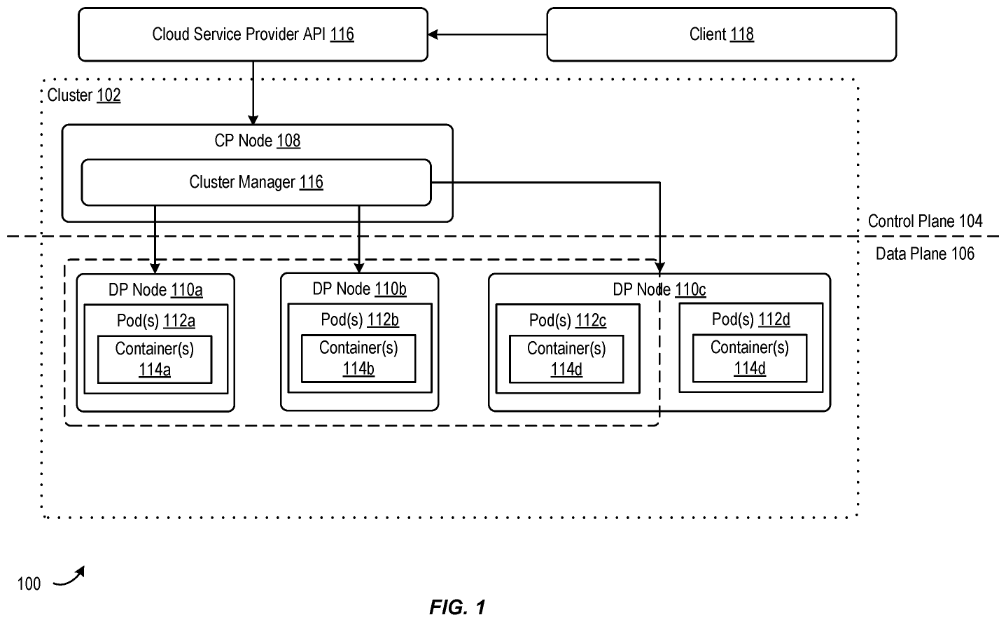

FIG. 1 shows a simplified diagram of an exemplary cloud-computing environment 100 including a managed cluster (e.g., cluster 102), according to at least one embodiment. The cluster 102 may include control plane and data plane components. By way of example, control plane 104 may include any suitable number of control plane components (e.g., control plane (CP) node 108). Data plane 106 may include any suitable number of data plane nodes (e.g., data plane (DP) node 110a, DP node 110b, and DP node 110c, collectively “DP nodes 110”). Each data plane node (“node,” for brevity) may be an example of a worker machine (virtual or physical) that is configured to execute pods (e.g., Kubernetes pods) and/or containers. Pod(s) 112a-d (collectively, “pods 112”) are individually an example of a pod (e.g., a Kubernetes pod) that may include any suitable number of container(s) (e.g., container(s) 114a-d, collectively “containers 114”, respectively). A node may host virtualized resources of multiple tenants in a multi-tenant computing environment, or the node may be dedicated to host resources of a single tenant. DP node(s) 110a and 110b may individually be an example of a node that includes dedicated computing hardware that hosts a pod(s)/container(s) of a single tenant. DP node(s) 110c may be an example of a node that supports pod(s)/container(s) corresponding to multiple tenants. Pod(s) 112 may each be a deployable unit of computing including any suitable number of respective containers. Pod(s) 112 may be created and managed by the cluster manager 116. Cluster manager 116 may include a container orchestration system (e.g., Kubernetes) with which software deployment and scaling may be managed.

Customers can communicate with the cluster 102 using a cloud service provider application programming interface (API) 116. The cloud service provider API 116 may be used to receive messages from computing devices (e.g., client 118) in one or more networks which may be controlled by a customer. Cloud service provider API 116 may include a rule set and/or specification defining received and/or transmitted message structure and/or data fields. Messages received by the cloud service provider API 116 may include, but are not limited to, requests to create a new cluster, requests to create or update a node pool (e.g., a collection of nodes such as DP nodes 110), requests to add/remove a node to/from a cluster (e.g., cluster 102), requests to execute a workload, or the like.

The cloud service provider API 116 may forward the received messages to cluster manager 116. In some embodiments, cluster manager 116 is a management service (e.g., a distributed or centralized service) provided by one or more computing devices that is configured to manage the cluster 102. The cluster manager 116 may be configured to provision nodes such as DP nodes 110. Provisioning a node may include reserving hardware resources, installing an operating system and/or required files on the node, and adding the node to cluster 102. Cluster manager 116 may allocate workloads to the provisioned nodes. In some embodiments, allocating a workload may include matching and/or assigning one or more pods to a node (also referred to as “scheduling”).

DP nodes 110 may be configured to run containerized applications. Client 118 may be utilized to send a workload (e.g., program code, an application, and any suitable libraries, binaries, configuration files, and/or frameworks on which the program code/application depend) to the cluster manager 116 of cluster 102. The workload may be packaged within a container (e.g., a user-defined container, a container generated by the cluster manager 116, etc.). When packaged within a container, the workload may be referred to as a “containerized workload.” A “containerized application” similarly refers to a container that includes the program code for an application and any suitable libraries, binaries, configuration files, and/or frameworks on which execution of the application depends). In some embodiments, one or more containers may be packaged within a pod (e.g., a user-defined pod, a pod generated by the cluster manager 116 to include the container(s)). The cluster manager 116 may monitor the number of DP nodes and the number of workloads and may scale (e.g., increase or decrease the number of nodes allocated to the cluster 102) to ensure that the number of nodes of the cluster 102 meet the cluster's workload and/or data storage needs.

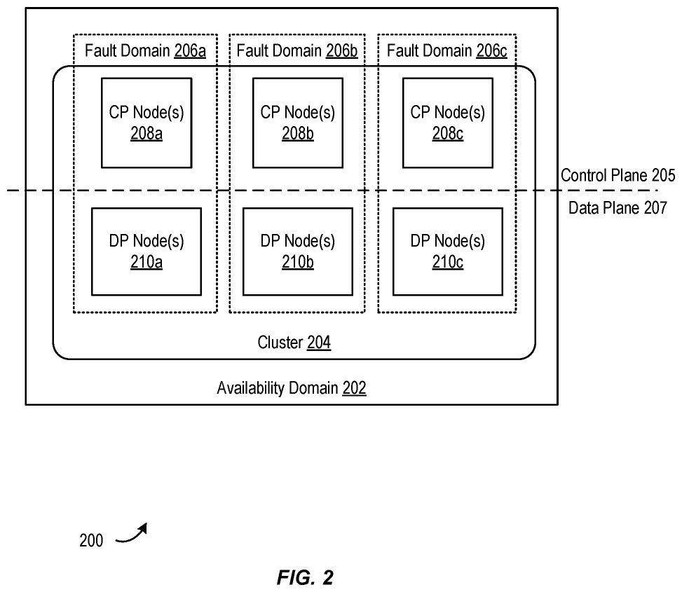

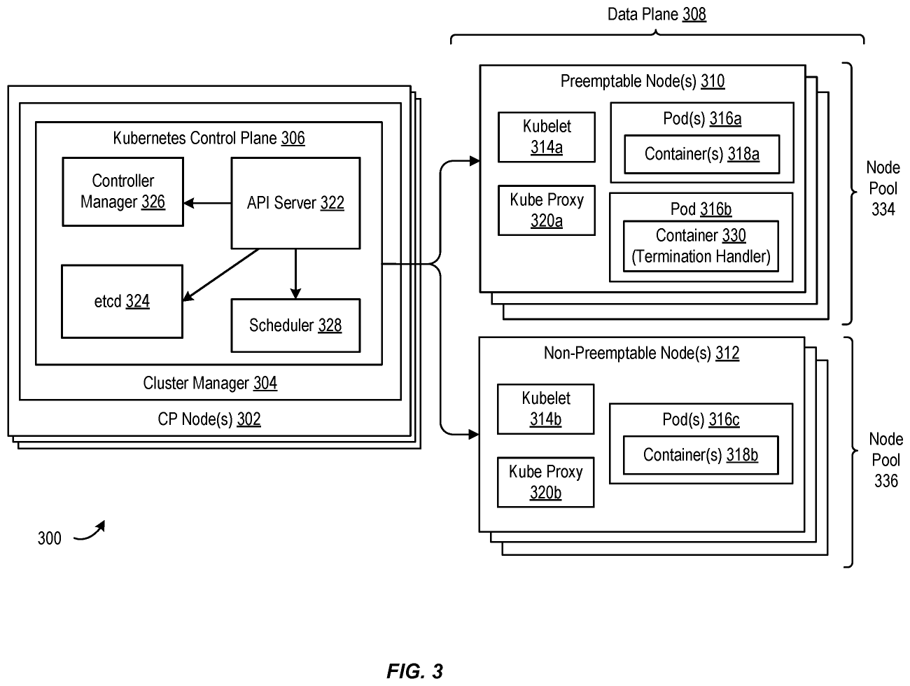

FIG. 2 shows a simplified diagram of a cloud-computing environment 200 including multiple fault domains within an availability domain (e.g., availability domain 202), according to at least one embodiment. An “availability domain” may include a set of data centers (e.g., one or more data centers within a geographical region). In some embodiments, availability domain may include cluster 204 (e.g., an example of cluster 102 of FIG. 1). In some embodiments, an availability domain may include any suitable number of fault domains (e.g., fault domains 206a-c, collectively “fault domains 206”). A “fault domain” refers to a grouping of hardware and infrastructure within an availability domain. Fault domains may have separate power sources. Fault domains may be utilized to ensure that a hardware failure or a compute hardware maintenance event that affects one domain does not affect the other fault domains. In some embodiments, control plane (CP) components (e.g., CP node(s) 208a-c, collectively “CP nodes 208”, each an example of CP node 108 of FIG. 1) of control plane 205 (e.g., the control plane 104 of FIG. 1) may be evenly distributed across fault domains 206. CP node(s) 208 may include any suitable number of master nodes on which a Kubernetes control plane (e.g., Kubernetes control plane 306 of FIG. 3) executes. In some embodiments, three (or more) replicas of each CP component may be used. In some embodiments, these CP components may be evenly distributed among the fault domains, for durability purposes, as depicted with CP node(s) 208.

Similarly, data plane 207 (e.g., data plane 106 of FIG. 1) may include data plane (DP) components (e.g., DP node(s) 210a-c, collectively “DP nodes 210,” each an example of the DP nodes 110 of FIG. 1. Each of DP nodes 210 may be associated with a corresponding fault domain. In some embodiments, node metadata may indicate a particular fault domain for the node. When a pod is created, may contain a node selector for a fault domain, and the CP node(s) of that fault domain may be responsible for scheduling the pod to an appropriate node (e.g., one of the DP nodes within that fault domain).

FIG. 3 shows a simplified diagram depicting example cloud-computing environment 300 in which one or more preemptible nodes may be generated and configured, according to at least one embodiment. Environment 300 may include control plane node(s) 302 (e.g., CP node 108 of FIG. 1, CP nodes 208 of FIG. 2, etc.) on which a cluster manager 304 (e.g., cluster manager 116, a cluster management service) may execute. Cluster manager 304 may include a container orchestration platform (e.g., Kubernetes control plane 306). Kubernetes control plane 306 is an example of Kubernetes, an open-source platform for managing containerized workloads and services that facilitates declarative configuration and automation. Kubernetes provides an architecture that consists of a control plane (e.g., Kubernetes control plane 306) and data plane (e.g., data plane 308, an example of data plane 106 of FIG. 1, data plane 207 of FIG. 2, etc.). Data plane components operate on worker nodes (e.g., preemptible node(s) 310 non-preemptible node(s) 312, each an example of the DP nodes 110 of FIG. 1, DP node(s) 210 of FIG. 2, etc.). Worker nodes are responsible for running the various workloads as pods (e.g., pods 112 of FIG. 1). The control plane is responsible for the orchestration of the worker nodes, it is responsible for scheduling workloads on the worker nodes, managing a number of pods, performing security policy management, enforcing quotas and resources for workloads, and providing availability management of the workloads.

As depicted, data plane 308 includes a number of software agents (e.g., kubelet 314a, kubelet 314b) that may be configured to provide functionality for interacting with the Kubernetes control plane 306. In some embodiments, each node (e.g., each of preemptible node(s) 310 and non-preemptible nodes 312 may execute a corresponding kubelet. Each kubelet may be configured to carry out various functions such as: 1) adding/removing a node to/from a cluster (e.g., cluster 102 of FIG. 1), 2) communicating with the Kubernetes control plane 306 (e.g., to provide the status of pods (e.g., pod(s) 316a-c, collectively “pods 316”) and/or nodes, etc.), 3) communicating with the Kubernetes control plane 306 for any suitable purpose, 4) obtaining images (e.g., container images) from specific registries (e.g., from object storage and/or a designated storage location) for execution in pod(s) at the node, 5) interfacing with the container runtime executing at each node to run the container images (e.g., images corresponding to container(s) 318a and 318b, examples of containers 114 of FIG. 1), 6) interfacing with a container network interface (CNI) (not depicted) for providing networking for the pods, or the like.

Data plane 308 may include any suitable number of kube proxies (e.g., kube proxy 320a and 320b). A kube proxy (e.g., kube proxy 320a) may serve as a network proxy for each node. In some embodiments, kube proxy 320a may maintain network rules that allow network communication to the pod(s) of the node (e.g., pod(s) 316a and 316b). In some embodiments, kube proxy 320a maintains networking rules and/or IP tables for services defined in the cluster and manages the rules and/or IP tables to load-balance requests to the service's backend pods. Kube proxy 320a may be configured to connect to API server 322 to watch for changes to services and/or pods. As pods get created/destroyed, kube proxy 320a may update its IP tables so that network traffic sent to the service IP gets correctly routed to one of the backing pods.

The API server 322 may be a RESTFUL API for the Kubernetes control plane 306. The API server 322 may be configured to carry out cluster operations such as deployment and pod deletion and queries the cluster state and its objects. API server 322 may be stateless and may be configured to use etcd 324, discussed below, as storage. Cluster manager 304 may be configured to communicate with API server 322 to initiate and manipulate deployments on a cluster (e.g., on the preemptable node(s) 310 and/or the non-preemptable node(s) 312). API server 322 may be designed to scale horizontally—that is, it scales by deploying more instances. Several instances of API server 322 may be run, concurrently, and traffic may be balanced between those instances.

Etcd 324 may be a distributed key/value storage used by Kubernetes Control Plane 306 to store cluster data. Etcd 324 may be configured to utilize a consensus algorithm (e.g., reliable, replicated, redundant, and fault-tolerant (RAFT) algorithm) to elect a leader and achieve strong data consistency. Etcd 324 may be regularly backed up for disaster recovery according to any suitable predefined schedule or frequency.

Controller manager 326 may include any suitable number of the controllers shipped with Kubernetes, such as replication controller (not depicted) and a namespace controller (not depicted), as a part of its binaries. Controller manager 326 represents the Kubernetes control loop which automatically responds to new events by checking the API Server 322 and modifies the cluster state to match the desired cluster state. For example, upon manual deletion of a pod, the controller manager 326, or a controller of the controller manager 326, may be configured to attempt spin up a new pod to modify the cluster state to match the number of pods in the cluster to that of a desired state. Some example controllers include: a node controller (e.g., a controller responsible for noticing and responding when nodes go down), a job controller (e.g., a controller configured to watch for job objects that represent one-off tasks, then creates pods to run those tasks to completion), a controller configured to identify a parameter of a node (e.g., a label indicating the node is a preemptible node) and, in response, deploys a particular pod to the node (e.g., a pod that includes a containerized application such as container 330 of FIG. 3), an EndpointSlice controller (e.g., a controller configured to populate EndpointSlice objects to provide a link between Services and pods), and a ServiceAccount controller (e.g., a controller for creating default ServiceAccounts for new namespaces), to name a few.

Scheduler 328 may be configured to assign pods (e.g., pod(s) 316a) to cluster nodes (e.g., preemptible node(s) 310). The scheduler 328 may compile a list of feasible nodes (a “candidate list”) on which the pod can be placed. This is referred to as “filtering.” The nodes in the candidate list may be scored based on constraints and criteria (e.g., based on individual and collective resource requirements, hardware/software/policy constraints, affinity and anti-affinity specifications, data locality, inter-workload interference, and/or deadlines). The pod (e.g., pod 316b) may be assigned to the node with the highest score. The scheduler 328 may be configured to notify the API Server 322 of the assignment decision. The API server 322 may be configured to handle communicating with the selected node's Kubelet (e.g., kubelet 314a) to spawn the pod and deploy its containers (e.g., container 330, an example of container(s) 114 of FIG. 1). The Kubelet of each node may utilize a secure communication channel to the Kubernetes control plane 306 to present authorization credentials, with which the privileges it needs to carry out the communication is granted. The Kubelet in turn communicates with the container runtime via a container runtime interface (not depicted) to manage pod(s) 316a and pod 316b.

In some embodiments, a cluster may include one or more node pools. By way of example, any suitable combination of preemptable node(s) 310 and/or non-preemptable node(s) 312 may from node pool 332. In some embodiments, preemptable node(s) 310 and non-preemptable node(s) 312 may correspond to separate node pools (e.g., node pool 334 and node pool 336, respectively). A “node pool” refers to a group of nodes within the cluster that have the same configuration (e.g., a configuration defined by parameters of a node configuration specification). Each node in a given node pool may be labeled or otherwise associated with a label that identifies the node pool to which the node belongs. As a non-limiting example, each of the preemptible node(s) 310 may be associated with a shared node configuration specification (referred to as a “preemptible node configuration”) and labeled or otherwise tagged as belonging to the preemptible node pool 310. In some embodiments, each of the preemptible node(s) 310 may be tagged or otherwise associated with label that indicates the nodes as being preemptable (e.g., having a preemptable capacity type indicating the node may be reclaimed at any suitable time based at least in part on on-demand capacity requests).

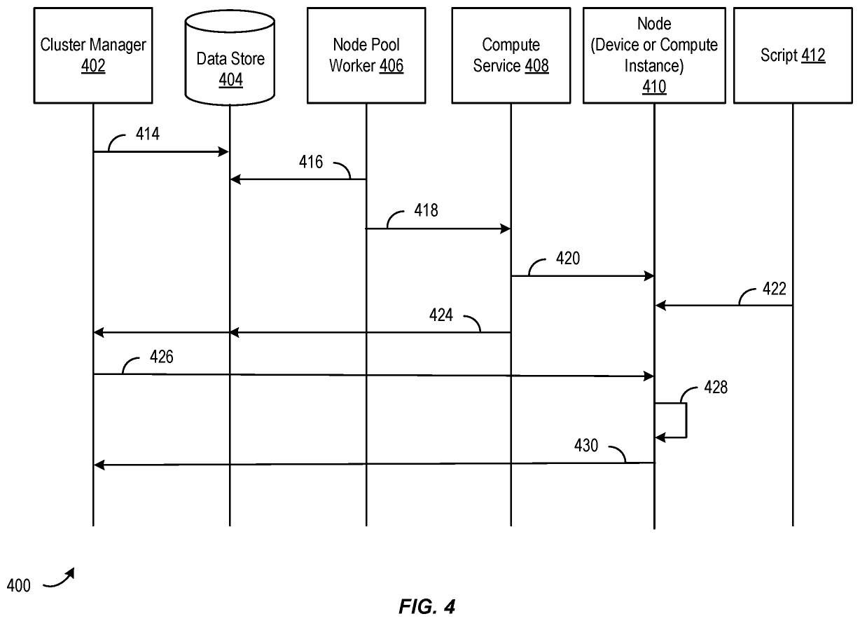

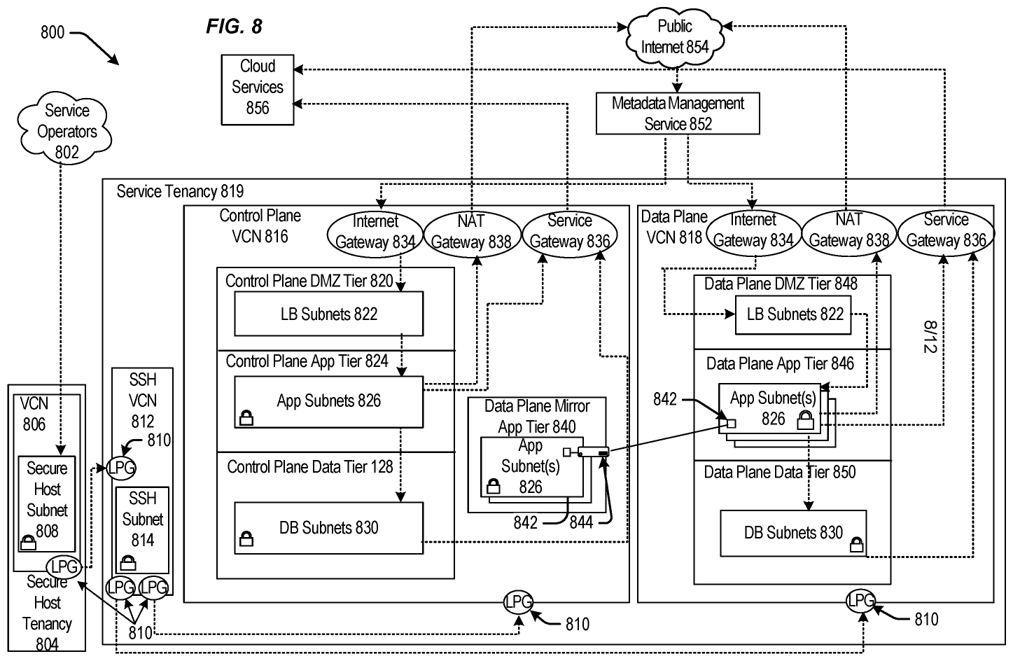

FIG. 4 includes a flow diagram depicting an example method 400 for generating and labeling a preemptible node, according to at least one embodiment. The flow may be executed by the cluster manager 402 (an example of the cluster manager 304 of FIG. 3), node pool worker 406, compute service 408 (an example of cloud service 856 of FIG. 8).

In some embodiments, cluster manager 402 may operate as part of a control plane (e.g., control plane 104 of FIG. 1, control plane VCN 816 of FIG. 8). The control plane may own canonical details of all customer-facing service resources and may be configured to receive (e.g., via cloud service provider API 116 of FIG. 1 from client 118 of FIG. 1) work requests that include intended state data that describes an intended state of a set of data plane resources (e.g., DP nodes 110 of FIG. 1). In some embodiments, a work request may include a request to create and add one or more nodes to a cluster (e.g., cluster 102 of FIG. 1). As a non-limiting example, a work request may be a request to add a node pool (e.g., node pool 334 of FIG. 3) that includes any suitable number of preemptible nodes (e.g., preemptable node(s) 310 of FIG. 3).

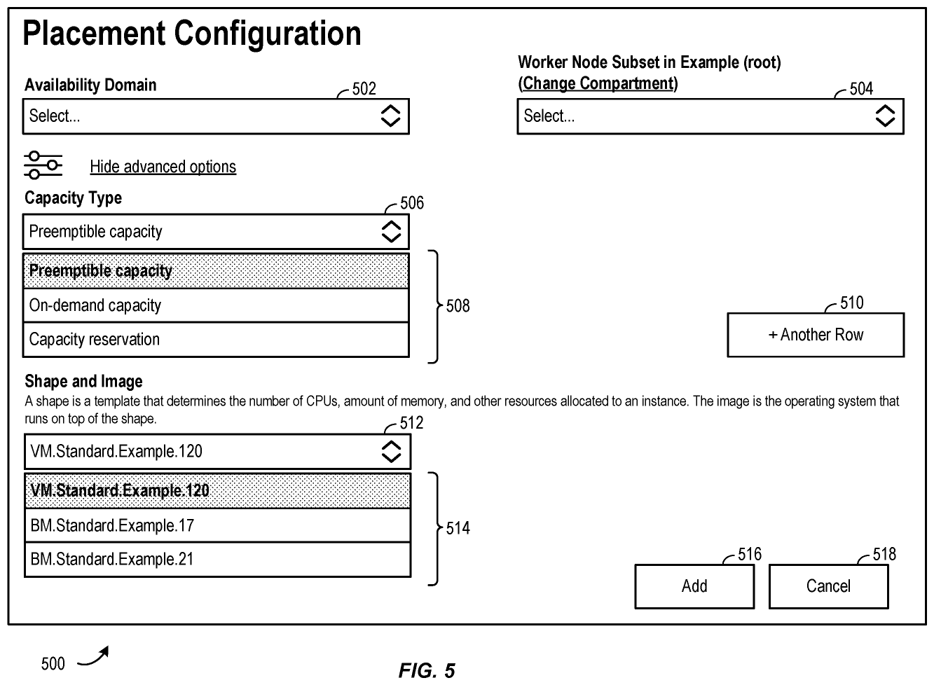

FIG. 5 depicts an example user interface 500 for requesting one or more preemptible nodes (e.g., preemptable node(s) 310 of FIG. 3), according to at least one embodiment. User interface 500 may be presented at client 118 of FIG. 1 and a user may utilize the interface to request a node from a cloud service provider. User interface element 502 may be used to select an availability domain where the customer would like to add the new node. In some embodiments, the user interface 500 may include a separate user interface element (not depicted) to select a region. In some embodiments, user interface 500 may be presented based on a selection made from a user interface that is associated with a particular region and thus, the region may be inferred from the selection. A region can be a geographic area and the infrastructure for each region can be divided into availability domains (each being an example of the availability domain 202 of FIG. 2). The hardware and infrastructure for each availability domain may be isolated so that the failure of one availability domain may not impact the other availability domains.

User interface element 504 may be used to select compartment for the new node. The cluster may be a new cluster and the node may be added as the first node or the new node may be added to a preexisting cluster with one or more nodes. User interface element 506 may be used to identify a capacity type for the new node. Upon selecting user interface element 506 (e.g., a drop-down menu, although other selection methods may be employed), options 508 may be presented from which the user may select. As depicted, an option for preemptible capacity is presented. User interface element 510 may be selected to add a request for a second new node. Any suitable number of nodes may be added via user interface element 510.

In some embodiments, user interface element 512 may be used to select a shape and/or image. A “shape” refers to a predefined template that determines attributes of the new node(s). These attributes may include a number of CPUs, an amount of memory, and/or other resources allocated to the node (e.g., a compute instance or device). An “image” may include the operating system that executes on the resources allocated in accordance with the shape. Upon selecting user interface element 512 (e.g., a drop-down menu, although other selection methods may be employed), options 514 may be presented from which the user may select. As depicted, an option for “VM.Standard.Example.120” is selected. This selection may correspond to a predefined shape and image that specifies various attributes of the new node as described above. User interface element 816 may be selected to submit a request for the node(s). User interface element 518 may be selected to cancel the request.

Returning to FIG. 4, the cluster manager 402 may receive a request (e.g., from the cloud service provider API 116 of FIG. 1. The request may be submitted via a user interface that is similar to the user interface 500 of FIG. 5 described above.

The method 400 may begin at 414 where, the cluster manager 402 receives a request (e.g., from the cloud service provider API 116 of FIG. 1. The request may be submitted via a user interface that is similar to the user interface 500 of FIG. 5 described above. In some embodiments, the request may identify one or more new nodes (e.g., preemptible node(s) 310) that are to be added to a cluster. In some embodiments, a selection made via user interface element 504 may indicate that the new node(s) are to be a new node pool (e.g., node pool 334 of FIG. 3). In some embodiments, cluster manager 402 (or another suitable control plane component) may store the received request within data store 404. Data store 404 may be configured to store work requests and/or an intended state data corresponding to an intended state of a data plane (e.g., data plane 106 of FIG. 1).

At 416, node pool worker 406 obtain the request from data store 404. Node pool worker 406 may be one of many worker nodes that are individually configured to obtain intended state data and execute a predefined workflow for bringing the associated data plane in line with the intended state data. Any suitable number of nodes may be identified within intended state data. As depicted in FIG. 4, the intended state data may include parameters for adding node 410 (e.g., one of the preemptible node(s) 310 of FIG. 3) to the cluster managed by cluster manager 402. The intended state data, including at least the attributes specified with user interface 500, may define attributes of the node requested including, but not limited to, an identifier for the node, an availability domain corresponding to the node, a shape corresponding to the node, a number of processing units of the node, an amount of random access memory (RAM) of the node, an amount of memory (e.g., disk memory), a role (e.g., a data node, a master node, etc.), a status (e.g., healthy), or the like. In some embodiments, the intended state data obtained from data store 404 may include any suitable number of parameters defining the software to be executed on the one or more nodes (e.g., node 410).

Although not depicted, in some embodiments, a monitoring service may be configured to scan data store 404 periodically (e.g., according to a predefined frequency and/or schedule) to identify new instances of intended state data (e.g., corresponding to the request). Upon identifying the existence of the intended state data, the monitoring service may execute operations to cause node pool worker 406 to receive the intended state data at 416. By way of example, the monitoring service may determine that the intended state data has no corresponding actual state data (indicating the resources do not yet exist in the data plane) and in response to this determination, the monitoring service may trigger a workflow to be created (e.g., by another service (e.g., a Workflow as a Service (WFaaS) Service, an example of cloud services 856 of FIG. 8) configured to create such workflows based on intended state data. In some embodiments, the monitoring service may pass along the intended state data (or any suitable portion of the intended state data) as arguments (e.g., to the WFaaS Service) which may cause node pool worker 406 to be assigned to execute the operations of the workflow in accordance with the intended state data.

At 418, node pool worker 406 may execute a workflow that transmits the intended state data (e.g., node metadata including the parameters of the requested node as obtained from data store 404) to compute service 408. Compute service 408 may be an example of the cloud services 856 of FIG. 8. Compute service 408 may be configured to provision and manage compute hosts (e.g., compute instances). Compute service 408 may be configured to execute any suitable operations to generate/supply virtual hosts (e.g., virtual machine instances, bare metal instances, etc.) on which containerized applications/workflows may execute. In some embodiments, compute service 408 may execute any suitable operations to provision (e.g., reserve) hardware to create the node 410 (e.g., a compute instance). In some embodiments, node 410 may be a physical machine or a compute instance that is configured to run containerized applications/workloads that are deployed to node 410.

At 420, compute service 408 may execute any suitable operations to provision (e.g., reserve) hardware for node 410, install an operating system, install a container runtime, install agent(s) or proxies (e.g., kubelet 314a, kube proxy 320a, etc.), or any suitable operations to configure the node 410 to be capable of executing containerized applications/workloads. In some embodiments, the intended state data/parameters of the requested node may indicate a preemptible capacity type corresponding to the selection indicated via user interface element 506 of FIG. 5. Based at least in part on the intended state data indicating the preemptible capacity type, the compute service 408 may associated the node with a label indicating the node 410 is a node that is associated with a preemptible capacity type.

In some embodiments, script 412 may be executed at 422 to associate the node 410 with a label that indicates the node 410 is associated with a preemptible capacity type. As a non-limiting example, the compute service 408 may store node metadata at the node 410 (or elsewhere) that indicates the node 410 is a preemptible node. Script 412, when executed, may obtain the node metadata associated with node 410 and identify from the node metadata that the node 410 is a preemptible node. Based on this identification, the script 412 may cause the node 410 to be tagged, labeled, or otherwise associated with a label (e.g., an alphanumeric string) that indicates the node 410 is associated with a preemptible capacity type. The preemptible capacity type label may distinguish node 410 from nodes having a different capacity type (e.g., an on-demand capacity type).

As yet another example, cluster manager 402 may execute script 412 or similar operations to label node 410 when the node 410 is added to the cluster that cluster manager 402 manages (e.g., cluster 105 of FIG. 1).

At 424, compute service 408 may send any suitable data to the cluster manager 402 (directly, or via data store 404) that indicates the node 410 has been provisioned/configured as a preemptible node.

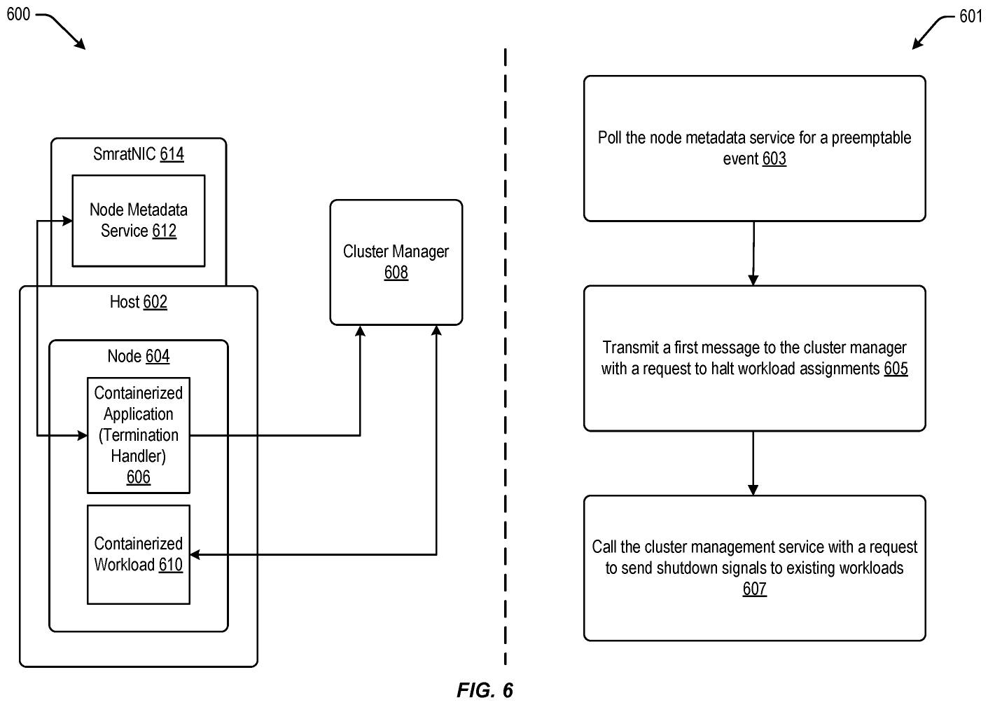

At 426, cluster manager 402 (a component of cluster manager 402, such as controller manager 326) may execute any suitable operations to deploy a pod (e.g., pod 316b) to node 410. By way of example, controller manager 326 may include any suitable number of controllers, one of which may be configured to determine whether a node (e.g., node 410) is associated with a label (e.g., a label indicating that the node is associated with a preemptible capacity type). Upon detecting the label (e.g., via corresponding node metadata associated with the node), the controller may be configured to deploy pod 316b to the node 410 (e.g., to Kubelet 314a, or another suitable agent/process running on node 410). In some embodiments, pod 316b may include container 330 of FIG. 3. Container 330 may also be referred to as a termination handler. The container 330 may include program code that, when executed monitors the node for a preemption event. The operations for monitoring the node are discussed in further detail with respect to FIG. 6 below. Kubelet 314a may execute any suitable operations to prepare the container(s) of the pod for execution.

At 428, node 410 or any suitable component of node 410 (e.g., container 330) may monitor for a preemption event. Upon detecting a preemption event of node 410, the node 410 (e.g., container 330) may execute any suitable operations for triggering a set of shutdown operations.

At 430, node 410 (e.g., container 330) may transmit any suitable data to cluster manager 402 to indicate a preemption event has occurred. Cluster manager 402 may execute any suitable operations for shutting down the container(s) executing at the node 410. In some embodiments, receiving an indication from the node 410 that a preemption event has occurred (e.g., that the node 410 is going to be preempted within a specified time period), the cluster manager 402 may exclude the node 410 from a candidate list from which subsequent pod assignments are made. This may ensure that subsequent pods are not deployed to the node 410. In some embodiments, transmitting the data to cluster manager 402 may cause cluster manager 402 to execute any suitable cordon and drain operations using the Kubernetes control plane 306 of FIG. 3.

Although not depicted, subsequent to performing the method 400, the cluster manager 402 may execute any suitable operations for replacing the node 410 (e.g., with another preemptible node). In some embodiments, the cluster manager 402 may periodically transmit a request, or store data within data store 404 to attempt replacement of the node 410 once node 410 has been preempted. In a similar manner as discussed above, the request may be obtained by node worker 406 and transmitted to compute service 408. Replacement may be attempted periodically (e.g., 6 requests per hour, a request every 10 mins, etc.) until the preempted node (e.g., node 410) is replaced with a new preemptible node. In some embodiments, when a node replacement is attempted, the replacement may be attempted in every fault domain (e.g., fault domains 206a, 206b, and 206c of FIG. 2) unless otherwise specified by the user (e.g., as part of the initial request for node 410). In some embodiments, the program code executed for replacement may attempt replacement, then if unsuccessful may attempt the replacement again after one minute. If replacement is still unsuccessful, the replacement may be attempted any suitable number of times, doubling the time between successive retries until the time reaches 60 minutes.

FIG. 6 illustrates a simplified diagram 600 and an example method 601 for detecting and responding to a preemption event corresponding to a preemptive node, according to at least one embodiment. The method 601 is illustrated as a logical flow diagram, each operation of which can be implemented in hardware, computer instructions, or a combination thereof. In the context of computer instructions, the operations may represent computer-executable instructions stored on one or more computer-readable storage media that, when executed by one or more processors, perform the recited operations. Generally, computer-executable instructions include routines, programs, objects, components, data structures and the like that perform particular functions or implement particular data types. The order in which the operations are described is not intended to be construed as a limitation, and any number of the described operations can be combined in any order and/or in parallel to implement the process.

Turning to diagram 600 in greater detail, host 602 can be a device (e.g., hardware that is utilized in a multi-tenant computing environment) that runs one or more nodes simultaneously or host 602 may be dedicated computing hardware that hosts a single node at a time. The node 604 (an example of the node 410 of FIG. 4, the preemptible node(s) 310 of FIG. 3) may be a preemptable node, but the host 602 may host additional preemptive or on-demand nodes (not depicted here). Node 602 may include a containerized application 606 (e.g., an example of the container 330 of FIG. 3) that can be added to the node when the node is provisioned or added by the cluster manager 608 (an example of the cluster manger 402 of FIG. 4, the cluster manager 304 of FIG. 3). As the node is added to the cluster, or at any suitable time, the cluster manager 608 may detect (e.g., from a tag, from node metadata associated with the node) that the node 604 is a preemptible node (e.g., a node that is associated with a label indicating a preemptible capacity type). If such a label is detected, the cluster manager 608 may deploy containerized application 606 (e.g., container 330 via pod 316b) that may execute within node 604. In some embodiments, and at any suitable time, other containerized workloads (e.g., containerized workload 610) may be deployed and execute at node 604. Communication between the host 602 and the cluster manager 608 (e.g., a cluster management service, one of the cloud services 856 of FIG. 8, etc.) can occur via a network such as a local area network (LAN), a wide area network (WAN), or the Internet.

Containerized application 606 may be referred to as a “termination handler.” A termination handler may be any suitable program code that, when executed, monitors node metadata for an indication of a preemption event. In some embodiments, an instance of a node metadata service (e.g., node metadata service 612) may execute at the host 602, within node 604 and/or at a device that is communicatively connected to host 602. By way of example, node metadata service 612 may execute at a smart network interface card (e.g., smart NIC 614). Smart NC 614 may be a “bump in the wire” networking device configured to provide enhanced networking functions for networking traffic passing to and from the host 602 (e.g., tunneling for a firewall, tunneling to other smart NICs, enforcing firewall rules, and the like). In some embodiments, smart NIC 614 may be a virtual device that may be connected to one or more physical NICs of the host 602. The smart NIC 614 may be a network virtualization device that may comprise physical ports that enable it to be connected to one or more host machines (e.g., host 602) and to one or more top of rack (TOR) switches (not depicted). A port of smart NIC 614 may be host-facing or network-facing where a host-facing port is connected to host 602 and a network-facing port is connected to a TOR switch. Smart NIC 614 may receive packets and frames from host 602 (e.g., packets and frames generated by containerized application 606 and/or containerized workload 610) via a host-facing port and forward the packets and frames to a TOR switch via a network-facing port.

Node metadata service 612 may be configured to obtain node metadata corresponding to the node 604. In some embodiments, this node metadata may be provided by a compute service (e.g., computer service 408 of FIG. 4). Node metadata may be monitored (e.g., by the containerized application 606) for a preemption event. A preemption event refers to an intent by the system to preempt of the node 604. When the node is preempted, the system may reclaim the node. As a non-limiting example, a request may be received for an on-demand node. If capacity within the cloud-computing environment is limited, there may be insufficient resources with which the on-demand node may be provided. In such cases, the system may be configured to identify one or more preemptible nodes (e.g., node 604). The resources of the preemptible node(s) may be reclaimed, reconfigured, and used to provide the on-demand node.

To monitor for a preemption event, containerized application 606 may obtain node metadata from node metadata service 612 (e.g., from requesting the node metadata from the node metadata service 612 periodically (also referred to as “polling”), from receiving a periodic transmission of the node metadata from the node metadata service 612, from obtaining the node metadata from a storage location at which the node metadata service 612 previously stored the information, or the like). Node metadata may include a flag, a timer, or any suitable indication that the node 604 is to be preempted. In some embodiments, the node metadata may indicate when the node preemption is planned. By way of example, a timer, or period of time may be included in the node metadata that indicates that the node 604 will be preempted/reclaimed by the system (e.g., by computer service 408) within a time period (e.g., after two minutes has elapsed, etc.). As a result, containerized application 606 may transmit a preemption message (and/or any suitable data) to the cluster manager 608 to trigger a set of shutdown operations.

Turning to method 601 in greater detail, at step 603, the containerized application 606 may poll the node metadata service 612 to determine whether a preemptable event has occurred. The containerized application 606 may send regular messages (e.g., requests for node metadata) to the node metadata service 612 and, in response, the node metadata service 612, may send a message indicating whether a preemptable event has occurred and/or providing the node metadata associated with node 604. Preemptable events may be detected based at least in part on data indicating that or when the node 604 is scheduled to be removed from the host 602. In addition, a preemptable event may occur whenever the host is scheduled for maintenance. In some embodiments, the node metadata service 612 may transmit a message to the containerized application 606 when the node metadata service 612 detects a preemptable event without the containerized application 606 polling the node metadata service 612.

At step 605, the containerized application 606 may transmit a first message to the cluster manager 608. The first message may indicate a request to halt workload assignments to the node 604. In response to receiving the first message, the cluster manager 608 may execute operations to stop allocating containerized workloads (e.g., examples of the containerized workload 610) to the node 604. Halting these assignments can reduce the possibility that a containerized workload fails because workloads that are assigned after a preemption event was detected are likely to fail. In some embodiments, halting the assignment of pods may correspond to executing cordon operations associated with the Kubernetes control plane 306 of FIG. 3, a component of the cluster manager 608. In some embodiments, halting these assignments (e.g., executing cordon operations) may include removing the node 604 from a list of candidate nodes from which subsequent pod assignments are selected and/or marking the node 604 as not being schedulable. By removing the node 604 from this candidate list and/or marking the node as not being schedulable, the cluster manager 608 may ensure that no new containerized applications and/or workflows are assigned to node 604.

At step 607, a second message may be transmitted from containerized workload 610 to cluster manager 608 to request shutdown of existing workloads executing at the node 604. In some embodiments, containerized workload 110 can contain custom code (e.g., hooks) that may be invoked by shutdown signals sent to the containerized workload 110 by the cluster manager 608. These shutdown signals may cause the containerized workload 110 to halt execution, save progress, and send the saved progress to the cluster manager 608. In some embodiments, transmitting the second message may cause the cluster manager 608 to execute drain operations that delete all pods (except a pod within which containerized application 606 executes) from the node 604. These drain operations may be executed by the Kubernetes control plane 306. In some embodiments, the first and second message may be combined in a single message that causes both subsequent pod assignments to exclude node 604 and also sends shutdown signals to shut down the workloads executing at node 604 (e.g., containerized workload 610). In some embodiments, Kubernetes control plane 306 may utilize an eviction API to effectuate cordon and drain operations to mark the node as unschedulable and to remove any suitable pod from the node 604.

Through detecting the preemption of the node 604 and executing the operations discussed in connection with FIG. 6, the node 604 may be preempted with reduced risk of interrupting the workloads executing at the node 604.

Although not depicted, subsequent to executing method 601, the cluster manager 608 may execute any suitable operations for replacing the node 604 (e.g., with another preemptible node). In some embodiments, the cluster manager 608 may periodically transmit a request (or store a request in data store 404 of FIG. 4) to replace the node 604 once node 604 has been preempted.

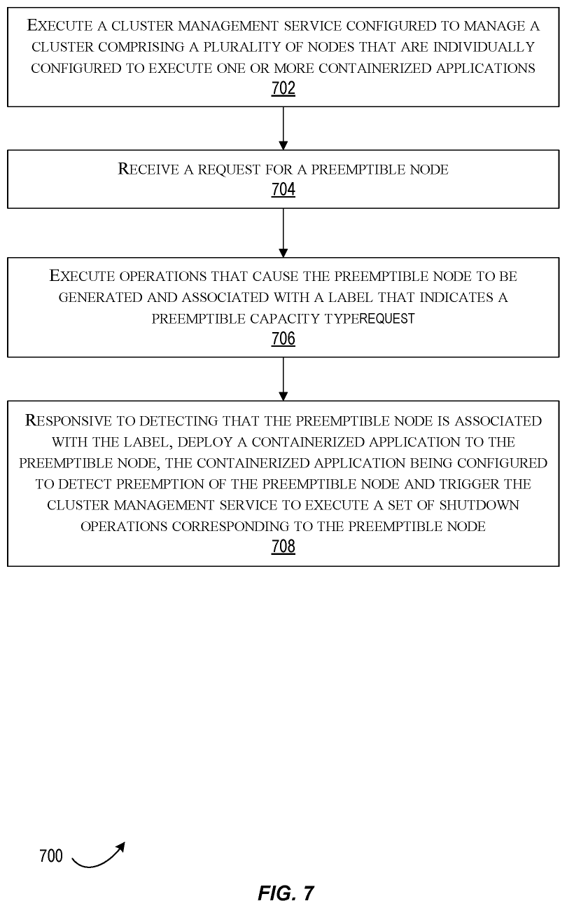

FIG. 7 is a block diagram depicting an example method 700 managing preemptable nodes, in accordance with at least one embodiment. The method 700 is illustrated as a logical flow diagram, each operation of which can be implemented in hardware, computer instructions, or a combination thereof. The operations discussed below may represent computer-executable instructions stored in one or more computer-readable storage media that, when executed by one or more processors, perform the recited operations. The order in which the operations are described is not intended to limit this disclosure, and any number of the described operations can be performed in any suitable order, combined in any order and/or in parallel to implement the process.

The method 700 may begin at 702, where a cluster management service may be executed. The cluster management service may be an example of the cluster manager 116 of FIG. 1, 304 of FIG. 3, 402 of FIG. 4, and/or 608 of FIG. 6. The cluster management service may be configured to manage a cluster (e.g., cluster 105 of FIG. 1) comprising a plurality of nodes (e.g., DP nodes 110 of FIG. 1) that are individually configured to execute one or more containerized applications (e.g., containerized application 606, an example of the container 330 of FIG. 3).

At 704, a request for a preemptible node (e.g., node 604) may be received (e.g., by the cluster management service). In some embodiments, the request may be initiated from user interface 500 of FIG. 5.

At 706, the cluster management service may execute operations that cause the preemptible node to be generated and associated with a label that indicates a preemptible capacity type. By way of example, the cluster management service may store parameters received in the request within a data store (e.g., data store 402 of FIG. 4). In some embodiments, a worker node (node worker 406 of FIG. 4) may obtain the parameters of the request and provide any suitable combination of those parameters to a compute service (e.g., the compute service 408 of FIG. 4). The compute service may provision and/or configure the preemptible node (e.g., node 410 of FIG. 4) for operation. In some embodiments, the node may be labeled with a label that indicates the preemptible capacity type. The label may be associated with the node by the compute service 408, via execution of a script (e.g., script 412), by the cluster management service, or the like).

At 708, responsive to detecting that the preemptible node is associated with the label, the cluster management service may deploy a containerized application to the preemptible node. By way of example, based at least in part on detecting the label associated with node 410 indicating that node 410 is a preemptible node, the cluster management service (e.g., a controller of the cluster management service) may deploy pod 316b associated with container 330 of FIG. 3. The container 330 may include a containerized application that is, when executed, configured to detect preemption of the preemptible node and trigger the cluster management service to execute a set of shutdown operations corresponding to the preemptible node. By way of example, the container 330 may include containerized application 606 that may execute the operations discussed above in connection with FIG. 6, including method 601.

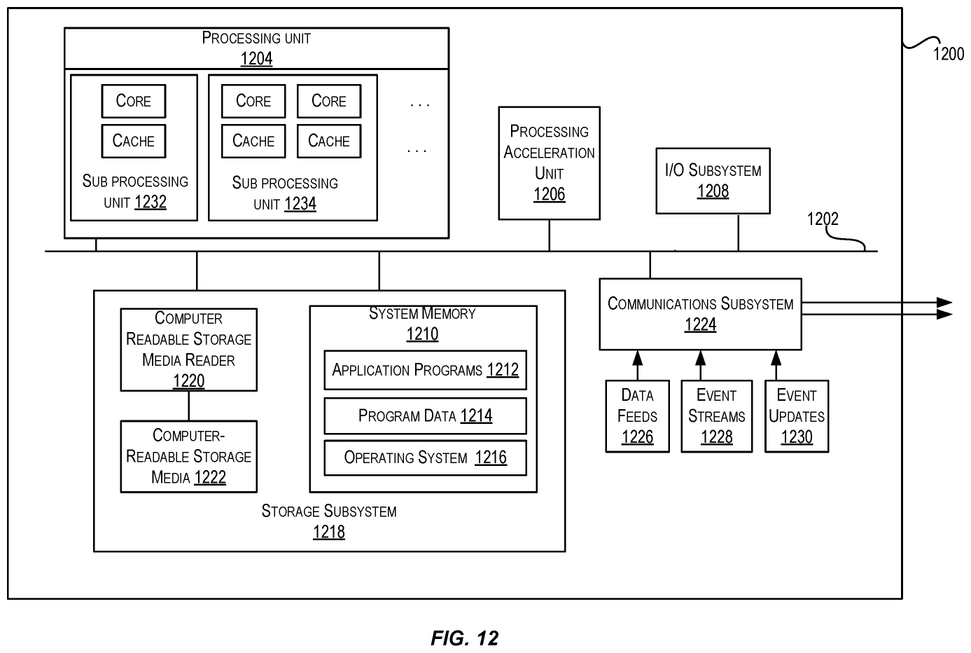

The various systems and functionalities depicted in the figures and described above may be provided as part of infrastructure provided by a cloud services provider (CSP) for provisioning one or more data centers that may provide one or more cloud services. The accompanying description below describes examples of infrastructure that may be used to implement the cloud services, including Infrastructure-as-a-Service services. FIG. 12 depicts an example computer system that may be used to execute and implement the various functionalities described in this disclosure.

### Example Cloud Service Infrastructure Architecture

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 8 is a block diagram 800 illustrating an example pattern of an IaaS architecture, according to at least one embodiment. Service operators 802 can be communicatively coupled to a secure host tenancy 804 that can include a virtual cloud network (VCN) 806 and a secure host subnet 808. In some examples, the service operators 802 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 806 and/or the Internet.

The VCN 806 can include a local peering gateway (LPG) 810 that can be communicatively coupled to a secure shell (SSH) VCN 812 via an LPG 810 contained in the SSH VCN 812. The SSH VCN 812 can include an SSH subnet 814, and the SSH VCN 812 can be communicatively coupled to a control plane VCN 816 via the LPG 810 contained in the control plane VCN 816. Also, the SSH VCN 812 can be communicatively coupled to a data plane VCN 818 via an LPG 810. The control plane VCN 816 and the data plane VCN 818 can be contained in a service tenancy 819 that can be owned and/or operated by the IaaS provider.

The control plane VCN 816 can include a control plane demilitarized zone (DMZ) tier 820 that acts as a perimeter network (e.g., portions of a corporate network between the corporate intranet and external networks). The DMZ-based servers may have restricted responsibilities and help keep breaches contained. Additionally, the DMZ tier 820 can include one or more load balancer (LB) subnet(s) 822, a control plane app tier 824 that can include app subnet(s) 826, a control plane data tier 828 that can include database (DB) subnet(s) 830 (e.g., frontend DB subnet(s) and/or backend DB subnet(s)). The LB subnet(s) 822 contained in the control plane DMZ tier 820 can be communicatively coupled to the app subnet(s) 826 contained in the control plane app tier 824 and an Internet gateway 834 that can be contained in the control plane VCN 816, and the app subnet(s) 826 can be communicatively coupled to the DB subnet(s) 830 contained in the control plane data tier 828 and a service gateway 836 and a network address translation (NAT) gateway 838. The control plane VCN 816 can include the service gateway 836 and the NAT gateway 838.

The control plane VCN 816 can include a data plane mirror app tier 840 that can include app subnet(s) 826. The app subnet(s) 826 contained in the data plane mirror app tier 840 can include a virtual network interface controller (VNIC) 842 that can execute a compute instance 844. The compute instance 844 can communicatively couple the app subnet(s) 826 of the data plane mirror app tier 840 to app subnet(s) 826 that can be contained in a data plane app tier 846.

The data plane VCN 818 can include the data plane app tier 846, a data plane DMZ tier 848, and a data plane data tier 850. The data plane DMZ tier 848 can include LB subnet(s) 822 that can be communicatively coupled to the app subnet(s) 826 of the data plane app tier 846 and the Internet gateway 834 of the data plane VCN 818. The app subnet(s) 826 can be communicatively coupled to the service gateway 836 of the data plane VCN 818 and the NAT gateway 838 of the data plane VCN 818. The data plane data tier 850 can also include the DB subnet(s) 830 that can be communicatively coupled to the app subnet(s) 826 of the data plane app tier 846.

The Internet gateway 834 of the control plane VCN 816 and of the data plane VCN 818 can be communicatively coupled to a metadata management service 852 that can be communicatively coupled to public Internet 854. Public Internet 854 can be communicatively coupled to the NAT gateway 838 of the control plane VCN 816 and of the data plane VCN 818. The service gateway 836 of the control plane VCN 816 and of the data plane VCN 818 can be communicatively couple to cloud services 856.

In some examples, the service gateway 836 of the control plane VCN 816 or of the data plane VCN 818 can make application programming interface (API) calls to cloud services 856 without going through public Internet 854. The API calls to cloud services 856 from the service gateway 836 can be one-way: the service gateway 836 can make API calls to cloud services 856, and cloud services 856 can send requested data to the service gateway 836. But, cloud services 856 may not initiate API calls to the service gateway 836.

In some examples, the secure host tenancy 804 can be directly connected to the service tenancy 819, which may be otherwise isolated. The secure host subnet 808 can communicate with the SSH subnet 814 through an LPG 810 that may enable two-way communication over an otherwise isolated system. Connecting the secure host subnet 808 to the SSH subnet 814 may give the secure host subnet 808 access to other entities within the service tenancy 819.

The control plane VCN 816 may allow users of the service tenancy 819 to set up or otherwise provision desired resources. Desired resources provisioned in the control plane VCN 816 may be deployed or otherwise used in the data plane VCN 818. In some examples, the control plane VCN 816 can be isolated from the data plane VCN 818, and the data plane mirror app tier 840 of the control plane VCN 816 can communicate with the data plane app tier 846 of the data plane VCN 818 via VNICs 842 that can be contained in the data plane mirror app tier 840 and the data plane app tier 846.

In some examples, users of the system, or customers, can make requests, for example create, read, update, or delete (CRUD) operations, through public Internet 854 that can communicate the requests to the metadata management service 852. The metadata management service 852 can communicate the request to the control plane VCN 816 through the Internet gateway 834. The request can be received by the LB subnet(s) 822 contained in the control plane DMZ tier 820. The LB subnet(s) 822 may determine that the request is valid, and in response to this determination, the LB subnet(s) 822 can transmit the request to app subnet(s) 826 contained in the control plane app tier 824. If the request is validated and requires a call to public Internet 854, the call to public Internet 854 may be transmitted to the NAT gateway 838 that can make the call to public Internet 854. Metadata that may be desired to be stored by the request can be stored in the DB subnet(s) 830.

In some examples, the data plane mirror app tier 840 can facilitate direct communication between the control plane VCN 816 and the data plane VCN 818. For example, changes, updates, or other suitable modifications to configuration may be desired to be applied to the resources contained in the data plane VCN 818. Via a VNIC 842, the control plane VCN 816 can directly communicate with, and can thereby execute the changes, updates, or other suitable modifications to configuration to, resources contained in the data plane VCN 818.

In some embodiments, the control plane VCN 816 and the data plane VCN 818 can be contained in the service tenancy 819. In this case, the user, or the customer, of the system may not own or operate either the control plane VCN 816 or the data plane VCN 818. Instead, the IaaS provider may own or operate the control plane VCN 816 and the data plane VCN 818, both of which may be contained in the service tenancy 819. This embodiment can enable isolation of networks that may prevent users or customers from interacting with other users', or other customers', resources. Also, this embodiment may allow users or customers of the system to store databases privately without needing to rely on public Internet 854, which may not have a desired level of threat prevention, for storage.

In other embodiments, the LB subnet(s) 822 contained in the control plane VCN 816 can be configured to receive a signal from the service gateway 836. In this embodiment, the control plane VCN 816 and the data plane VCN 818 may be configured to be called by a customer of the IaaS provider without calling public Internet 854. Customers of the IaaS provider may desire this embodiment since database(s) that the customers use may be controlled by the IaaS provider and may be stored on the service tenancy 819, which may be isolated from public Internet 854.

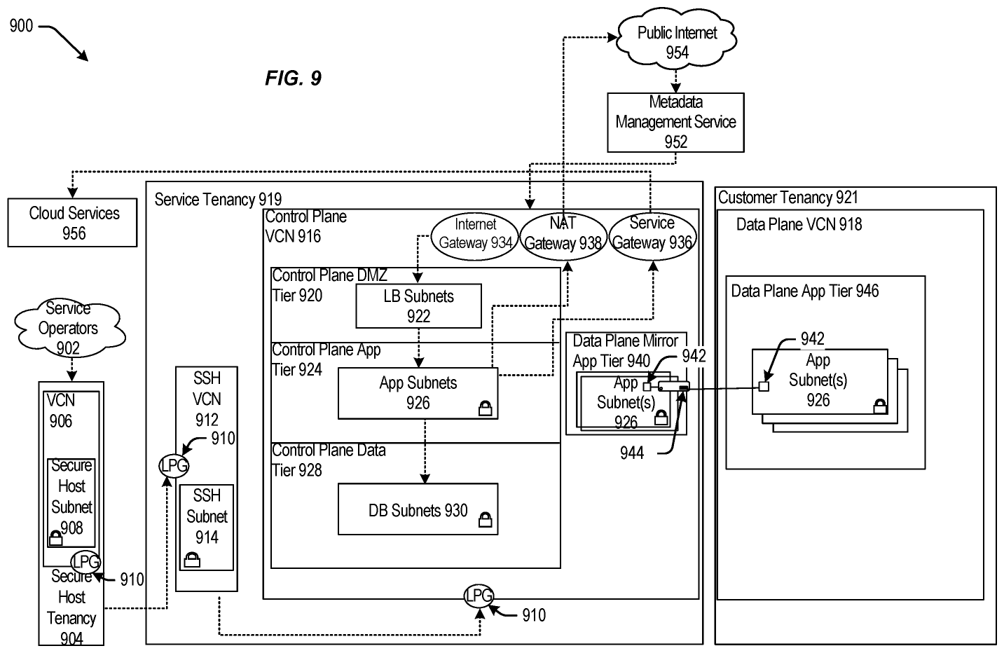

FIG. 9 is a block diagram 900 illustrating another example pattern of an IaaS architecture, according to at least one embodiment. Service operators 902 (e.g., service operators 802 of FIG. 8) can be communicatively coupled to a secure host tenancy 904 (e.g., the secure host tenancy 804 of FIG. 8) that can include a virtual cloud network (VCN) 906 (e.g., the VCN 806 of FIG. 8) and a secure host subnet 908 (e.g., the secure host subnet 808 of FIG. 8). The VCN 906 can include a local peering gateway (LPG) 910 (e.g., the LPG 810 of FIG. 8) that can be communicatively coupled to a secure shell (SSH) VCN 912 (e.g., the SSH VCN 812 of FIG. 8) via an LPG 810 contained in the SSH VCN 912. The SSH VCN 912 can include an SSH subnet 914 (e.g., the SSH subnet 814 of FIG. 8), and the SSH VCN 912 can be communicatively coupled to a control plane VCN 916 (e.g., the control plane VCN 816 of FIG. 8) via an LPG 910 contained in the control plane VCN 916. The control plane VCN 916 can be contained in a service tenancy 919 (e.g., the service tenancy 819 of FIG. 8), and the data plane VCN 918 (e.g., the data plane VCN 818 of FIG. 8) can be contained in a customer tenancy 921 that may be owned or operated by users, or customers, of the system.

The control plane VCN 916 can include a control plane DMZ tier 920 (e.g., the control plane DMZ tier 820 of FIG. 8) that can include LB subnet(s) 922 (e.g., LB subnet(s) 822 of FIG. 8), a control plane app tier 924 (e.g., the control plane app tier 824 of FIG. 8) that can include app subnet(s) 926 (e.g., app subnet(s) 826 of FIG. 8), a control plane data tier 928 (e.g., the control plane data tier 828 of FIG. 8) that can include database (DB) subnet(s) 930 (e.g., similar to DB subnet(s) 830 of FIG. 8). The LB subnet(s) 922 contained in the control plane DMZ tier 920 can be communicatively coupled to the app subnet(s) 926 contained in the control plane app tier 924 and an Internet gateway 934 (e.g., the Internet gateway 834 of FIG. 8) that can be contained in the control plane VCN 916, and the app subnet(s) 926 can be communicatively coupled to the DB subnet(s) 930 contained in the control plane data tier 928 and a service gateway 936 (e.g., the service gateway 836 of FIG. 8) and a network address translation (NAT) gateway 938 (e.g., the NAT gateway 838 of FIG. 8). The control plane VCN 916 can include the service gateway 936 and the NAT gateway 938.

The control plane VCN 916 can include a data plane mirror app tier 940 (e.g., the data plane mirror app tier 840 of FIG. 8) that can include app subnet(s) 926. The app subnet(s) 926 contained in the data plane mirror app tier 940 can include a virtual network interface controller (VNIC) 942 (e.g., the VNIC of 842) that can execute a compute instance 944 (e.g., similar to the compute instance 844 of FIG. 8). The compute instance 944 can facilitate communication between the app subnet(s) 926 of the data plane mirror app tier 940 and the app subnet(s) 926 that can be contained in a data plane app tier 946 (e.g., the data plane app tier 846 of FIG. 8) via the VNIC 942 contained in the data plane mirror app tier 940 and the VNIC 942 contained in the data plane app tier 946.

The Internet gateway 934 contained in the control plane VCN 916 can be communicatively coupled to a metadata management service 952 (e.g., the metadata management service 852 of FIG. 8) that can be communicatively coupled to public Internet 954 (e.g., public Internet 854 of FIG. 8). Public Internet 954 can be communicatively coupled to the NAT gateway 938 contained in the control plane VCN 916. The service gateway 936 contained in the control plane VCN 916 can be communicatively couple to cloud services 956 (e.g., cloud services 856 of FIG. 8).

In some examples, the data plane VCN 918 can be contained in the customer tenancy 921. In this case, the IaaS provider may provide the control plane VCN 916 for each customer, and the IaaS provider may, for each customer, set up a unique compute instance 944 that is contained in the service tenancy 919. Each compute instance 944 may allow communication between the control plane VCN 916, contained in the service tenancy 919, and the data plane VCN 918 that is contained in the customer tenancy 921. The compute instance 944 may allow resources, that are provisioned in the control plane VCN 916 that is contained in the service tenancy 919, to be deployed or otherwise used in the data plane VCN 918 that is contained in the customer tenancy 921.

In other examples, the customer of the IaaS provider may have databases that live in the customer tenancy 921. In this example, the control plane VCN 916 can include the data plane mirror app tier 940 that can include app subnet(s) 926. The data plane mirror app tier 940 can reside in the data plane VCN 918, but the data plane mirror app tier 940 may not live in the data plane VCN 918. That is, the data plane mirror app tier 940 may have access to the customer tenancy 921, but the data plane mirror app tier 940 may not exist in the data plane VCN 918 or be owned or operated by the customer of the IaaS provider. The data plane mirror app tier 940 may be configured to make calls to the data plane VCN 918 but may not be configured to make calls to any entity contained in the control plane VCN 916. The customer may desire to deploy or otherwise use resources in the data plane VCN 918 that are provisioned in the control plane VCN 916, and the data plane mirror app tier 940 can facilitate the desired deployment, or other usage of resources, of the customer.

In some embodiments, the customer of the IaaS provider can apply filters to the data plane VCN 918. In this embodiment, the customer can determine what the data plane VCN 918 can access, and the customer may restrict access to public Internet 954 from the data plane VCN 918. The IaaS provider may not be able to apply filters or otherwise control access of the data plane VCN 918 to any outside networks or databases. Applying filters and controls by the customer onto the data plane VCN 918, contained in the customer tenancy 921, can help isolate the data plane VCN 918 from other customers and from public Internet 954.

In some embodiments, cloud services 956 can be called by the service gateway 936 to access services that may not exist on public Internet 954, on the control plane VCN 916, or on the data plane VCN 918. The connection between cloud services 956 and the control plane VCN 916 or the data plane VCN 918 may not be live or continuous. Cloud services 956 may exist on a different network owned or operated by the IaaS provider. Cloud services 956 may be configured to receive calls from the service gateway 936 and may be configured to not receive calls from public Internet 954. Some cloud services 956 may be isolated from other cloud services 956, and the control plane VCN 916 may be isolated from cloud services 956 that may not be in the same region as the control plane VCN 916. For example, the control plane VCN 916 may be located in “Region 1,” and cloud service “Deployment 8,” may be located in Region 1 and in “Region 2.” If a call to Deployment 8 is made by the service gateway 936 contained in the control plane VCN 916 located in Region 1, the call may be transmitted to Deployment 8 in Region 1. In this example, the control plane VCN 916, or Deployment 8 in Region 1, may not be communicatively coupled to, or otherwise in communication with, Deployment 8 in Region 2.

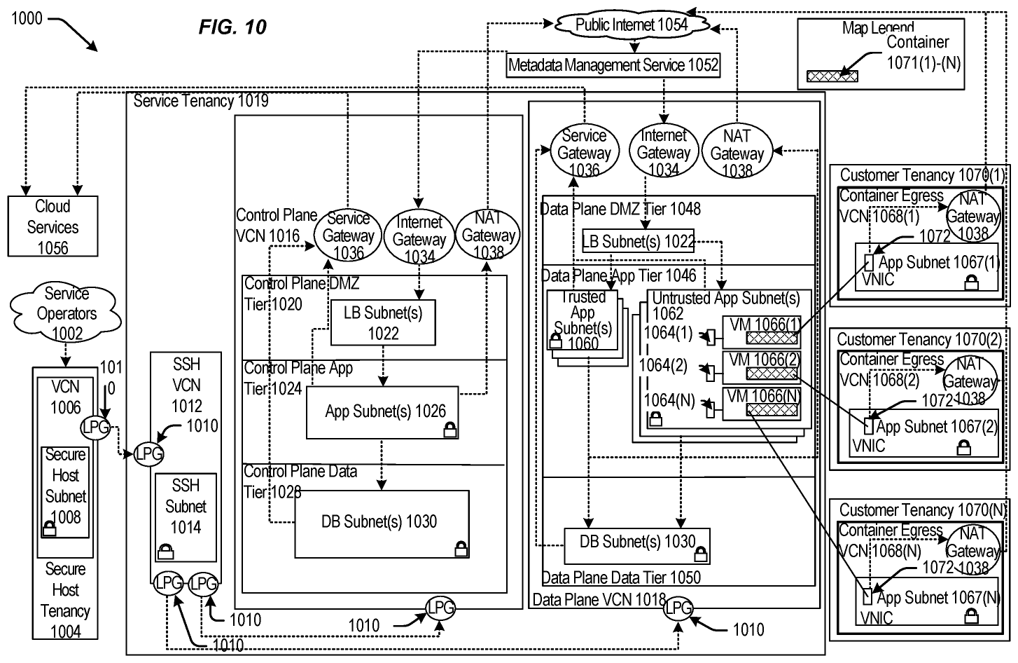

FIG. 10 is a block diagram 1000 illustrating another example pattern of an IaaS architecture, according to at least one embodiment. Service operators 1002 (e.g., service operators 802 of FIG. 8) can be communicatively coupled to a secure host tenancy 1004 (e.g., the secure host tenancy 804 of FIG. 8) that can include a virtual cloud network (VCN) 1006 (e.g., the VCN 806 of FIG. 8) and a secure host subnet 1008 (e.g., the secure host subnet 808 of FIG. 8). The VCN 1006 can include an LPG 1010 (e.g., the LPG 810 of FIG. 8) that can be communicatively coupled to an SSH VCN 1012 (e.g., the SSH VCN 812 of FIG. 8) via an LPG 1010 contained in the SSH VCN 1012. The SSH VCN 1012 can include an SSH subnet 1014 (e.g., the SSH subnet 814 of FIG. 8), and the SSH VCN 1012 can be communicatively coupled to a control plane VCN 1016 (e.g., the control plane VCN 816 of FIG. 8) via an LPG 1010 contained in the control plane VCN 1016 and to a data plane VCN 1018 (e.g., the data plane 818 of FIG. 8) via an LPG 1010 contained in the data plane VCN 1018. The control plane VCN 1016 and the data plane VCN 1018 can be contained in a service tenancy 1019 (e.g., the service tenancy 819 of FIG. 8).

The control plane VCN 1016 can include a control plane DMZ tier 1020 (e.g., the control plane DMZ tier 820 of FIG. 8) that can include load balancer (LB) subnet(s) 1022 (e.g., LB subnet(s) 822 of FIG. 8), a control plane app tier 1024 (e.g., the control plane app tier 824 of FIG. 8) that can include app subnet(s) 1026 (e.g., similar to app subnet(s) 826 of FIG. 8), a control plane data tier 1028 (e.g., the control plane data tier 828 of FIG. 8) that can include DB subnet(s) 1030. The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 834 of FIG. 8) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 8) and a network address translation (NAT) gateway 1038 (e.g., the NAT gateway 838 of FIG. 8). The control plane VCN 1016 can include the service gateway 1036 and the NAT gateway 1038.

The data plane VCN 1018 can include a data plane app tier 1046 (e.g., the data plane app tier 846 of FIG. 8), a data plane DMZ tier 1048 (e.g., the data plane DMZ tier 848 of FIG. 8), and a data plane data tier 1050 (e.g., the data plane data tier 850 of FIG. 8). The data plane DMZ tier 1048 can include LB subnet(s) 1022 that can be communicatively coupled to trusted app subnet(s) 1060 and untrusted app subnet(s) 1062 of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include one or more primary VNICs 1064(1)-(N) that can be communicatively coupled to tenant virtual machines (VMs) 1066(1)-(N). Each tenant VM 1066(1)-(N) can be communicatively coupled to a respective app subnet 1067(1)-(N) that can be contained in respective container egress VCNs 1068(1)-(N) that can be contained in respective customer tenancies 1070(1)-(N). Respective secondary VNICs 1072(1)-(N) can facilitate communication between the untrusted app subnet(s) 1062 contained in the data plane VCN 1018 and the app subnet contained in the container egress VCNs 1068(1)-(N). Each container egress VCNs 1068(1)-(N) can include a NAT gateway 1038 that can be communicatively coupled to public Internet 1054 (e.g., public Internet 854 of FIG. 8).

The Internet gateway 1034 contained in the control plane VCN 1016 and contained in the data plane VCN 1018 can be communicatively coupled to a metadata management service 1052 (e.g., the metadata management system 852 of FIG. 8) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively couple to cloud services 1056.

In some embodiments, the data plane VCN 1018 can be integrated with customer tenancies 1070. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1046. Code to run the function may be executed in the VMs 1066(1)-(N), and the code may not be configured to run anywhere else on the data plane VCN 1018. Each VM 1066(1)-(N) may be connected to one customer tenancy 1070. Respective containers 1071(1)-(N) contained in the VMs 1066(1)-(N) may be configured to run the code. In this case, there can be a dual isolation (e.g., the containers 1071(1)-(N) running code, where the containers 1071(1)-(N) may be contained in at least the VM 1066(1)-(N) that are contained in the untrusted app subnet(s) 1062), which may help prevent incorrect or otherwise undesirable code from damaging the network of the IaaS provider or from damaging a network of a different customer. The containers 1071(1)-(N) may be communicatively coupled to the customer tenancy 1070 and may be configured to transmit or receive data from the customer tenancy 1070. The containers 1071(1)-(N) may not be configured to transmit or receive data from any other entity in the data plane VCN 1018. Upon completion of running the code, the IaaS provider may kill or otherwise dispose of the containers 1071(1)-(N).

In some embodiments, the trusted app subnet(s) 1060 may run code that may be owned or operated by the IaaS provider. In this embodiment, the trusted app subnet(s) 1060 may be communicatively coupled to the DB subnet(s) 1030 and be configured to execute CRUD operations in the DB subnet(s) 1030. The untrusted app subnet(s) 1062 may be communicatively coupled to the DB subnet(s) 1030, but in this embodiment, the untrusted app subnet(s) may be configured to execute read operations in the DB subnet(s) 1030. The containers 1071(1)-(N) that can be contained in the VM 1066(1)-(N) of each customer and that may run code from the customer may not be communicatively coupled with the DB subnet(s) 1030.

In other embodiments, the control plane VCN 1016 and the data plane VCN 1018 may not be directly communicatively coupled. In this embodiment, there may be no direct communication between the control plane VCN 1016 and the data plane VCN 1018. However, communication can occur indirectly through at least one method. An LPG 1010 may be established by the IaaS provider that can facilitate communication between the control plane VCN 1016 and the data plane VCN 1018. In another example, the control plane VCN 1016 or the data plane VCN 1018 can make a call to cloud services 1056 via the service gateway 1036. For example, a call to cloud services 1056 from the control plane VCN 1016 can include a request for a service that can communicate with the data plane VCN 1018.

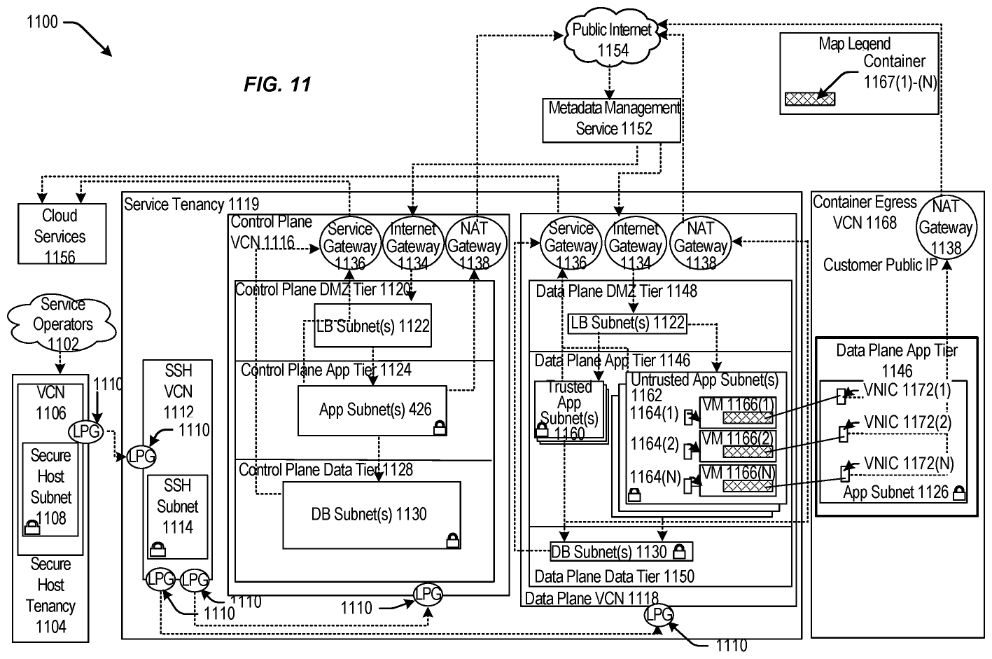

FIG. 11 is a block diagram 1100 illustrating another example pattern of an IaaS architecture, according to at least one embodiment. Service operators 1102 (e.g., service operators 802 of FIG. 8) can be communicatively coupled to a secure host tenancy 1104 (e.g., the secure host tenancy 804 of FIG. 8) that can include a virtual cloud network (VCN) 1106 (e.g., the VCN 806 of FIG. 8) and a secure host subnet 1108 (e.g., the secure host subnet 808 of FIG. 8). The VCN 1106 can include an LPG 1110 (e.g., the LPG 810 of FIG. 8) that can be communicatively coupled to an SSH VCN 1112 (e.g., the SSH VCN 812 of FIG. 8) via an LPG 1110 contained in the SSH VCN 1112. The SSH VCN 1112 can include an SSH subnet 1114 (e.g., the SSH subnet 814 of FIG. 8), and the SSH VCN 1112 can be communicatively coupled to a control plane VCN 1116 (e.g., the control plane VCN 816 of FIG. 8) via an LPG 1110 contained in the control plane VCN 1116 and to a data plane VCN 1118 (e.g., the data plane 818 of FIG. 8) via an LPG 1110 contained in the data plane VCN 1118. The control plane VCN 1116 and the data plane VCN 1118 can be contained in a service tenancy 1119 (e.g., the service tenancy 819 of FIG. 8).

The control plane VCN 1116 can include a control plane DMZ tier 1120 (e.g., the control plane DMZ tier 820 of FIG. 8) that can include LB subnet(s) 1122 (e.g., LB subnet(s) 822 of FIG. 8), a control plane app tier 1124 (e.g., the control plane app tier 824 of FIG. 8) that can include app subnet(s) 1126 (e.g., app subnet(s) 826 of FIG. 8), a control plane data tier 1128 (e.g., the control plane data tier 828 of FIG. 8) that can include DB subnet(s) 1130 (e.g., DB subnet(s) 1030 of FIG. 10). The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 834 of FIG. 8) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 8) and a network address translation (NAT) gateway 1138 (e.g., the NAT gateway 838 of FIG. 8). The control plane VCN 1116 can include the service gateway 1136 and the NAT gateway 1138.

The data plane VCN 1118 can include a data plane app tier 1146 (e.g., the data plane app tier 846 of FIG. 8), a data plane DMZ tier 1148 (e.g., the data plane DMZ tier 848 of FIG. 8), and a data plane data tier 1150 (e.g., the data plane data tier 850 of FIG. 8). The data plane DMZ tier 1148 can include LB subnet(s) 1122 that can be communicatively coupled to trusted app subnet(s) 1160 (e.g., trusted app subnet(s) 1060 of FIG. 10) and untrusted app subnet(s) 1162 (e.g., untrusted app subnet(s) 1062 of FIG. 10) of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include primary VNICs 1164(1)-(N) that can be communicatively coupled to tenant virtual machines (VMs) 1166(1)-(N) residing within the untrusted app subnet(s) 1162. Each tenant VM 1166(1)-(N) can run code in a respective container 1167(1)-(N) and be communicatively coupled to an app subnet 1126 that can be contained in a data plane app tier 1146 that can be contained in a container egress VCN 1168. Respective secondary VNICs 1172(1)-(N) can facilitate communication between the untrusted app subnet(s) 1162 contained in the data plane VCN 1118 and the app subnet contained in the container egress VCN 1168. The container egress VCN can include a NAT gateway 1138 that can be communicatively coupled to public Internet 1154 (e.g., public Internet 854 of FIG. 8).

The Internet gateway 1134 contained in the control plane VCN 1116 and contained in the data plane VCN 1118 can be communicatively coupled to a metadata management service 1152 (e.g., the metadata management system 852 of FIG. 8) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively couple to cloud services 1156.

In some examples, the pattern illustrated by the architecture of block diagram 1100 of FIG. 11 may be considered an exception to the pattern illustrated by the architecture of block diagram 1000 of FIG. 10 and may be desirable for a customer of the IaaS provider if the IaaS provider cannot directly communicate with the customer (e.g., a disconnected region). The respective containers 1167(1)-(N) that are contained in the VMs 1166(1)-(N) for each customer can be accessed in real-time by the customer. The containers 1167(1)-(N) may be configured to make calls to respective secondary VNICs 1172(1)-(N) contained in app subnet(s) 1126 of the data plane app tier 1146 that can be contained in the container egress VCN 1168. The secondary VNICs 1172(1)-(N) can transmit the calls to the NAT gateway 1138 that may transmit the calls to public Internet 1154. In this example, the containers 1167(1)-(N) that can be accessed in real-time by the customer can be isolated from the control plane VCN 1116 and can be isolated from other entities contained in the data plane VCN 1118. The containers 1167(1)-(N) may also be isolated from resources from other customers.

In other examples, the customer can use the containers 1167(1)-(N) to call cloud services 1156. In this example, the customer may run code in the containers 1167(1)-(N) that requests a service from cloud services 1156. The containers 1167(1)-(N) can transmit this request to the secondary VNICs 1172(1)-(N) that can transmit the request to the NAT gateway that can transmit the request to public Internet 1154. Public Internet 1154 can transmit the request to LB subnet(s) 1122 contained in the control plane VCN 1116 via the Internet gateway 1134. In response to determining the request is valid, the LB subnet(s) can transmit the request to app subnet(s) 1126 that can transmit the request to cloud services 1156 via the service gateway 1136.

It should be appreciated that IaaS architectures 800, 900, 1000, 1100 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

FIG. 12 illustrates an example computer system 1200, in which various embodiments may be implemented. The system 1200 may be used to implement any of the computer systems described above. As shown in the figure, computer system 1200 includes a processing unit 1204 that communicates with a number of peripheral subsystems via a bus subsystem 1202. These peripheral subsystems may include a processing acceleration unit 1206, an I/O subsystem 1208, a storage subsystem 1218 and a communications subsystem 1224. Storage subsystem 1218 includes tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1204, which can be implemented as one or more integrated circuits (e.g., a conventional microprocessor or microcontroller), controls the operation of computer system 1200. One or more processors may be included in processing unit 1204. These processors may include single core or multicore processors. In certain embodiments, processing unit 1204 may be implemented as one or more independent processing units 1232 and/or 1234 with single or multicore processors included in each processing unit. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, some, or all of the program code to be executed can be resident in processor(s) 1204 and/or in storage subsystem 1218. Through suitable programming, processor(s) 1204 can provide various functionalities described above. Computer system 1200 may additionally include a processing acceleration unit 1206, which can include a digital signal processor (DSP), a special-purpose processor, and/or the like.

I/O subsystem 1208 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1200 to a user or other computer. For example, user interface output devices may include, without limitation, a variety of display devices that visually convey text, graphics, and audio/video information such as monitors, printers, speakers, headphones, automotive navigation systems, plotters, voice output devices, and modems.

Computer system 1200 may comprise a storage subsystem 1218 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1204 provide the functionality described above. Storage subsystem 1218 may also provide a repository for storing data used in accordance with the present disclosure.

As depicted in the example in FIG. 12, storage subsystem 1218 can include various components including a system memory 1210, computer-readable storage media 1222, and a computer readable storage media reader 1220. System memory 1210 may store program instructions that are loadable and executable by processing unit 1204. System memory 1210 may also store data that is used during the execution of the instructions and/or data that is generated during the execution of the program instructions. Various different kinds of programs may be loaded into system memory 1210 including but not limited to client applications, Web browsers, mid-tier applications, relational database management systems (RDBMS), virtual machines, containers, etc.

System memory 1210 may also store an operating system 1216. Examples of operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1200 executes one or more virtual machines, the virtual machines along with their guest operating systems (GOSs) may be loaded into system memory 1210 and executed by one or more processors or cores of processing unit 1204.

System memory 1210 can come in different configurations depending upon the type of computer system 1200. For example, system memory 1210 may be volatile memory (such as random-access memory (RAM)) and/or non-volatile memory (such as read-only memory (ROM), flash memory, etc.) Different types of RAM configurations may be provided including a static random-access memory (SRAM), a dynamic random-access memory (DRAM), and others. In some implementations, system memory 1210 may include a basic input/output system (BIOS) containing basic routines that help to transfer information between elements within computer system 1200, such as during start-up.

Computer-readable storage media 1222 may represent remote, local, fixed, and/or removable storage devices plus storage media for temporarily and/or more permanently containing, storing, computer-readable information for use by computer system 1200 including instructions executable by processing unit 1204 of computer system 1200.

Computer-readable storage media 1222 can include any appropriate media known or used in the art, including storage media and communication media, such as but not limited to, volatile and non-volatile, removable, and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid-state RAM, dynamic RAM, static RAM, DRAM-based SSDs, magnetoresistive RAM (MRAM) SSDs, and hybrid SSDs that use a combination of DRAM and flash memory-based SSDs. The disk drives and their associated computer-readable media may provide non-volatile storage of computer-readable instructions, data structures, program modules, and other data for computer system 1200.

Machine-readable instructions executable by one or more processors or cores of processing unit 1204 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments communications subsystem 1224 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1224 may also be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
executing a cluster management service configured to manage a cluster comprising a plurality of nodes that are individually configured to execute one or more containerized applications;
receiving, by the cluster management service, a request for a preemptible node;
executing operations that cause the preemptible node to be generated and associated with a label that indicates a preemptible capacity type; and
responsive to detecting that the preemptible node is associated with the label, deploying, by the cluster management service, a containerized application to the preemptible node, the containerized application being configured to detect preemption of the preemptible node and trigger the cluster management service to execute a set of shutdown operations corresponding to the preemptible node.

2. The computer-implemented method of claim 1, further comprising implementing, by the cluster management service, a deployment controller that is configured to deploy the containerized application to preemptible nodes that are individually associated with the label indicating the preemptible capacity type.

3. The computer-implemented method of claim 1, wherein executing the operations that cause the preemptible node to be generated and associated with the label comprises:
transmitting, to a compute service, instructions to generate the preemptible node according to a preemptible node configuration, wherein generating the preemptible node causes the compute service to associate the preemptible node with preemptible metadata defined by the preemptible node configuration.

4. The computer-implemented method of claim 3, wherein generating the preemptible node causes a script to be executed that 1) identifies the preemptible node as being of the preemptible capacity type based at least in part on the preemptible metadata associated with the preemptible node and 2) associates the preemptible node with the label that indicates the preemptible capacity type.

5. The computer-implemented method of claim 1, wherein triggering the cluster management service to execute the set of shut down operations comprises transmitting, by the containerized application to the cluster management service, a preemption message that indicates that a preemption event corresponding to the preemptible node has occurred.

6. The computer-implemented method of claim 1, further comprising, responsive to receiving a preemption message from the containerized application, removing one or more containers executing on the preemptible node from a list of candidate containers to which new workloads are assignable.

7. The computer-implemented method of claim 1, wherein the containerized application is configured to detect the preemption of the preemptible node based at least in part on obtaining data from a node metadata service component executing at a device associated with the preemptible node.

8. The computer-implemented method of claim 7, wherein the device executing the node metadata service component executes at a smart network interface card that is communicatively connected to a host device on which the preemptible node executes.

9. A cloud computing system, comprising:
one or more processors; and
one or more memories storing computer-executable instructions that, when executed by the one or more processors, cause the cloud computing system to:
execute a cluster management service configured to manage a cluster comprising a plurality of nodes that are individually configured to execute one or more containerized applications;
receive a request for a preemptible node;
execute operations that cause the preemptible node to be generated and associated with a label that indicates a preemptible capacity type; and
responsive to detecting that the preemptible node is associated with the label, deploy a containerized application to the preemptible node, the containerized application being configured to detect preemption of the preemptible node and trigger the cluster management service to execute a set of shutdown operations corresponding to the preemptible node.

10. The cloud computing system of claim 9, wherein executing the computer-executable instructions further causes the cloud computing system to, responsive to receiving a preemption message from the containerized application, transmit a shutdown signal to one or more workloads being executed by the preemptible node.

11. The cloud computing system of claim 9, wherein the preemptible capacity type identifies the preemptible node as being reclaimable capacity that lacks a time guarantee.

12. The cloud computing system of claim 9, wherein the containerized application monitors node metadata provided by a node metadata service, wherein the node metadata indicates that the preemption of the preemptible node has been initiated.

13. The cloud computing system of claim 9, wherein executing the computer-executable instructions further causes the cloud computing system to assign low priority workloads to the preemptible node.

14. The cloud computing system of claim 9, wherein the containerized application is configured to detect the preemption of the preemptible node based at least in part on monitoring messages issued by a node metadata service.

15. A non-transitory computer-readable medium comprising computer-executable instructions that, when executed by one or more processors of a cloud computing system, cause the one or more processors of the cloud computing system to:
execute a cluster management service configured to manage a cluster comprising a plurality of nodes that are individually configured to execute one or more containerized applications;
receive a request for a preemptible node;
execute operations that cause the preemptible node to be generated and associated with a label that indicates a preemptible capacity type; and
responsive to detecting that the preemptible node is associated with the label, deploy a containerized application to the preemptible node, the containerized application being configured to detect preemption of the preemptible node and trigger the cluster management service to execute a set of shutdown operations corresponding to the preemptible node.

16. The non-transitory computer-readable medium of claim 15, wherein the preemption of the preemptible node is triggered based at least in part on a second request for an on-demand node that is unavailable due to current on-demand capacity of the cloud computing system.

17. The non-transitory computer-readable medium of claim 15, wherein the request for the preemptible node requests addition of a pool of preemptible nodes.

18. The non-transitory computer-readable medium of claim 17, wherein executing the operations that cause the preemptible node to be associated with the label further comprises associated each preemptible node of the pool of preemptible nodes with the label.

19. The non-transitory computer-readable medium of claim 15, wherein the set of shutdown operations comprise cordon and drain operations provided by a Kubernetes engine.

20. The non-transitory computer-readable medium of claim 15, wherein executing the computer-executable instructions further causes the one or more processors of the cloud computing system to transmit one or more requests for a replacement preemptible node corresponding to the preemptible node.
